(19) United States
(12) Patent Application Publication
(10) Pub. No.: US 2006/0013586 A1
(43) Pub. Date: Jan. 19, 2006

(54) Optical switching station and connection method for the same

(76) Inventors: Olaf Pichler, Backnang (DE); Jorg-Peter Elbers, Munchen (DE); Kenneth Guild, Essex (GB)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/509,430

(22) PCT Filed: Mar. 22, 2003
(86) PCT No.: PCT/EP03/02998

§ 371 Date: Aug. 18, 2005

(30) Foreign Application Priority Data
Mar. 23, 2002 (DE) 102 13 133.3
Jul. 10, 2002 (DE) 102 31 275.3

(51) Int. Cl. H04J 14/00

(52) U.S. Cl. 398/50

(57) ABSTRACT

An optical switching station comprises a first plurality of input channels for through data traffic, a second plurality of output channels for through data traffic, at least one first optical switching matrix comprising a first group of input connectors connected to the input channels on the switching station and a first group of output connectors connected to the output channels on the switching station, for connecting the input channels and the output channels to each other, and a group of one or more signal shaping units, each of a second group of output connectors being connected with an input of a signal shaping unit belonging to the group and each of a second group of input connectors being connected with an output from one of the signal shaping units.

The present invention relates to the area of optical telecommunication, in particular an optical cross connect and to a method for switching a communication signal in an optical cross connect.

Optical cross connects are used as nodes of optical networks. They are interconnected pair-wise by optical fibres on which telecommunication signals in the form of modulated light signals are transmitted from one cross connect to the other. An optical fibre can transfer a large number of communication signals at a same time in the form of modulated carrier waves at different wavelengths.

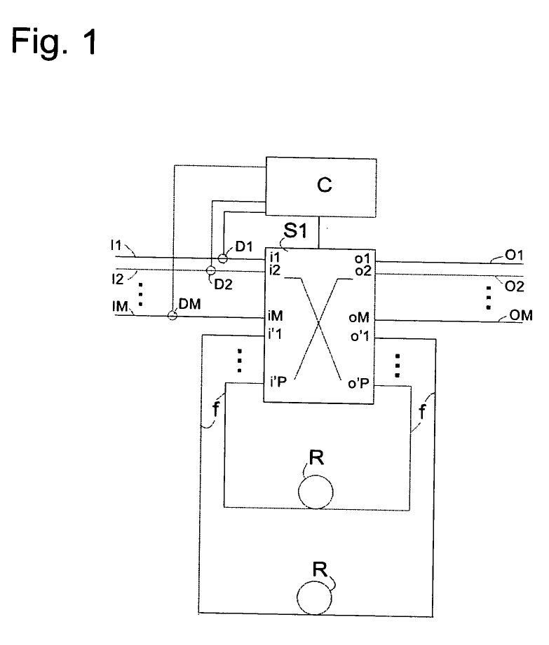

In an optical network, which uses wavelength-division multiplex, it is desirable that in a cross connect, communication signals, which are modulated on different carrier wavelengths of a same multiplex can be switched independently from one another. Therefore, situations may occur in which two communication signals that arrive at an optical cross connect by different input channels and have identical carrier wavelengths must be transmitted to the same output channel. Therefore, the optical cross connects in such an optical network require wavelength converters which allow to transpose the wavelength of one of these two communication signals to a wavelength which is not yet occupied on the output channel. Two examples for such a cross connect are described in R. Sabella et al., “Impact of Transmission Performance on Path Routing in All-Optical Transport Networks”, IEEE Journal of Lightwave Technology, volume 16, page 1965 et seq., 1998. The cross connect of FIG. 1(a) of this document has a plurality of switching fabrics, each of which has an output and an input connected to a block of wavelength converters. Demultiplexers for distributing the individual communication signals to the switching fabrics are formed by tuneable filters, which suggests that a given wavelength component of an arriving wavelength multiplex may be forwarded to various switching fabrics. In the cross connect of FIG. 1(b) of this document the demultiplexed information signals are all switched by a single switching fabric, which must apparently be capable of processing different wavelengths. There are several wavelength converters, which connect an output to an input of the switching fabric. The number of switches in such a switching fabric is very high, since it must be possible to connect any input to any output.

The object of the invention is to provide an optical cross connect and a method for switching an information signal in an optical cross connect which allow for wavelength conversion with little technical effort.

The object is achieved, on the one hand, by an optical cross connect having a first plurality of input channels for transit data traffic, a second plurality of output channels for transit data traffic, a plurality of first optical switching fabrics having a first group of input ports connected to the input channels of the cross connect and a first group of output ports connected to output channels of the cross connect, for interconnecting input and output channels, and a group of one or more signal shaping units formed as wavelength converters, and means for connecting a second group of output ports of the first optical switching fabrics to a respective input of a signal shaping unit of said group and means for connecting a second group of input ports of the first optical switching fabrics to a respective output of said signal shaping units, wherein each first switching fabric is provided for switching communication signals having a same wavelength assigned to said first switching fabric, and wherein the connecting means are adapted to connect the input and the output of a wavelength converter with different first switching fabrics. This optical cross allows to switch a communication signal which cannot be output directly to an output channel because on the desired output channel the wavelength of said communication signal is occupied, to an output port of the second group, so that the communication signal can be subjected to the required wavelength conversion, and then to supply the shaped signal to an input port of the second group of a first optical switching fabric, from where said first switching fabric can forward said signal to the initially desired output port.

As a means for connecting the signal shaping units to said at least one optical switching fabric, wired lines between an output or an input of a signal shaping unit and an input or output port, respectively, of the first switching fabric may be provided. This simple solution is absolutely sufficient if the signal shaping units are regenerators, since these maybe regarded as identical to each other, and it is not important which regenerator among may be several available regenerators actually transfers a communication signal for regeneration.

Alternatively, the connecting means may be formed of switching elements for selectively connecting an output or an input of a signal shaping unit to one of several input or output ports, respectively, of the first switching fabric. This is particularly advantageous if the cross connect comprises a plurality of first switching fabrics because the signal shaping units may then be assigned to one of the several first switching fabrics according to need. Such switching elements are also particularly desirable if the signal shaping units are wavelength converters, not each of which is necessarily capable of generating all the wavelengths which are transmitted on the input and output channels, and which should therefore advantageously be adapted to be connected to those first switching fabrics where a need for such a wavelength converter exists.

The connecting means preferably comprise at least one second switching fabric which selectively connects the second group output ports of the first switching fabrics with one of the wavelength converters. This allows to use simple wavelength converters which are sensitive in a broad wavelength range comprising all the wavelengths of the multiplex, but which are only adapted to transmit on a single wavelength of this multiplex. Here the second switching fabric is helpful for connecting each communication signal, the carrier wavelength of which has to be converted, to the required wavelength converter, regardless of at which out put port of which first switching fabric the signal to be converted is output.

Preferably, the connecting means further comprise at least a third switching fabric, which selectively connects the wavelength converters to one of the second group input ports of the first switching fabrics. The third switching fabric allows a dynamical assignment of the wavelength converters to different input ports of the second group, so that it is not necessary to assign a wavelength converter definitely to each of these input ports. Since the wavelength converters may thus be assigned to different input ports according to need, it is not necessary to provide an individual wavelength converter for each of these input ports, and the number of required wavelength converters is reduced.

Preferably, each input channel is connected to the first switching fabrics by a wavelength demultiplexer and/or the first switching fabrics are connected to the output channel by a wavelength multiplexer. Thus the input and output channels can be operated in wavelength-division multiplex, whereas inside the cross connect, the communication signals are dealt with individually, according to wavelength.

The inputs and outputs of the second group cannot only be used for supplying the signal shaping units, but also for locally dropping or adding communication signals from or to the multiplex, respectively.

Preferably, wavelength converters are used which have a tuneable transmitter part. These are more sophisticated than wavelength converters with a fixed-frequency transmitter part, but the number of them, which is needed to achieve a given degree of availability, is less.

Further features and advantages of the invention become apparent from the subsequent description of embodiments referring to the appended Figures.

FIG. 1 is a block diagram of an optical cross connect, not according to the invention, having a single switching fabric for operation at a single wavelength, with signal regenerators;

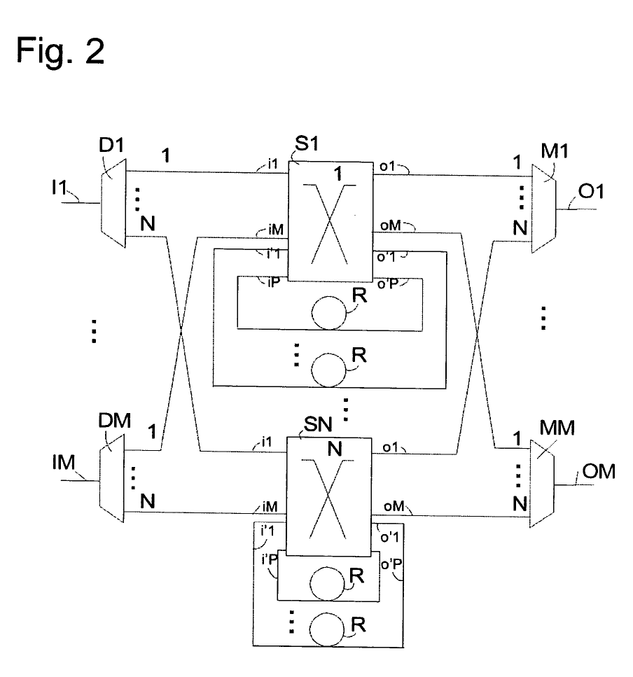

FIG. 2 is a more advanced cross connect having regenerators for wavelength-division multiplex operation;

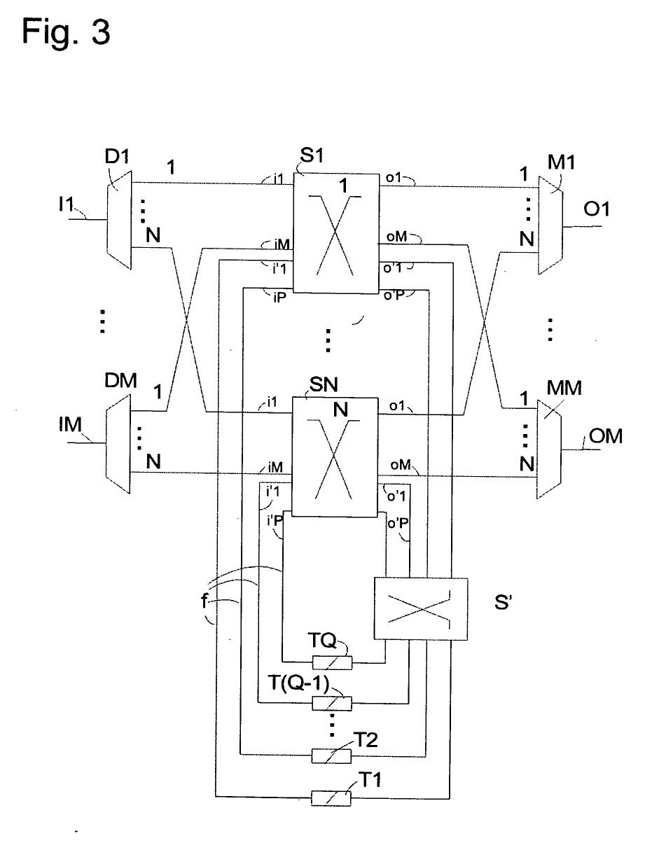

FIG. 3 is an optical cross connect according to the invention having fixed-frequency wavelength converters; and

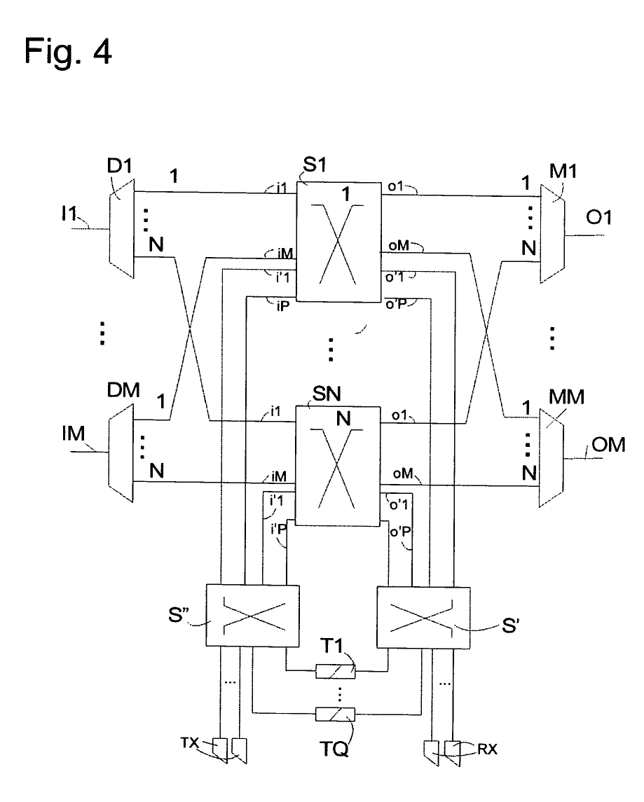

FIG. 4 is an optical cross connect according to the invention having tuneable wavelength converters.

The cross connect shown in FIG. 1 comprises a single switching matrix S1 having input ports i1, i2, . . . , iM, i′1, . . . , i′P and output ports o1, o2, . . . , oM, o′l, . . . , o′P. The first group i1, . . . , iM of the input ports is connected to input channels I1, . . . , IM, incidentally formed by optical fibres, each of which transfers one fixed-frequency communication signal. Correspondingly, a first group o1, . . . , oM of the output ports is connected to monochromatic output channels O1, . . . , OM. Output ports o′1, o′P are wired to input ports i′1, . . . , i′P via regenerators R by optical fibres f. A control circuit C receives routing information in a known manner, not shown here, which defines for each of the input ports i1 to iM, to which one of the output ports o1, . . . , oM of the first group it is to be connected. The control circuit C is further connected to detectors D1, D2, . . . , DM located upstream of each input port i1, i2, . . . , iM of the first group for detecting the quality of a communication signal arriving at the input port. If the detection result of one of these detectors indicates that the quality e.g. of the communication signal at the input port i2 is poor and requires regeneration, the control circuit C controls the switching fabric S1 at variance from the routing information which is supplied to it and which concerns the signal at input port i2, so that this communication signal is output at an output port of the second group, e.g. the output port o′1. Thus the communication signal transits one of the regenerators R and re-enters the switching fabric S1 at input port i′1. This input port i′1 is connected to the output port which is specified as the output port of the communication signal by the routing information. The regenerated communication signal thus transits the switching fabric S1 twice, before and after regeneration.

Communication signals which are found not to require regeneration transit the switching fabric S1 only once. The power losses experienced by these communication signals in the cross connect are (if eventual losses caused by the detectors D1, D2, . . . , Dn are neglected) identical to those of a cross connect without a regeneration functionality. The cross connect thus allows a selective regeneration without causing insertion losses in unregenerated communication signals.

In the cross connect of FIG. 1, the switching fabric S1 only processes communication signals of a same wavelength respectively originating from different input channels. As an alternative, it is of course possible to transfer several communication signals in wavelength-division multiplex on an input channel, to supply them to different input ports of the switching fabric via a demultiplexer and to supply communication signals that have been switched in the switching fabric via multiplexers to a common output channel. Since in such a set-up the size of the switching fabric increases proportional to the square of the number of signals to be switched, a design as shown in FIG. 2 is preferred for switching wavelength-division multiplexed communication signals.

FIG. 2 shows a cross connect having a regeneration function for an optical network using wavelength-division multiplex transmission. The input channels I1, . . . , IM, respectively, are optical fibres coming from a remote cross connect (not shown), on which a multiplex of communication signals modulated on different carrier wavelengths λ1, . . . , λN is transferred. Each of the input channels leads to a wavelength demultiplexer D1, D2, . . . , DM which spectrally decomposes the multiplex and distributes the communication signals contained therein to N switching fabrics S1, . . . , SN, each of which has one of the wavelengths λ1, . . . , λN assigned to it. The switching fabrics S1, . . . , SN correspond to the monochromatic switching fabric S1 of FIG. 1: they have a first group of input ports i1, . . . , iM, each of which is connected to one of the input channels I1, . . . , IM by one of the demultiplexers D1, . . . , DM, input ports i′1, . . . , i′P, each of which is connected to an output of a regenerator, output ports o1, . . . , oM of a first group and output ports o′1 to o′P which are respectively connected to inputs of the regenerators R. At each output port of the first group o1, . . . , oM, a wavelength multiplexer M1, . . . , MM having N inputs each, one for each switching fabric S1, . . . , SN, is connected which superimposes the communication signals received from the various switching fabrics at different wavelengths into a multiplex signal and outputs them to an output channel Ol, . . . , OM. Detectors for detecting the signal quality are provided at line sections connecting the demultiplexers to the switching fabrics, but like the control circuit, they are not shown for the sake of clarity. The operation of the individual switching fabrics is the same as in case of FIG. 1: communication signals at a carrier wavelength λn, n=1, . . . , N which are not to be regenerated transit once the switching fabric Sn assigned to them, a signal which is to be regenerated is branched in the switching fabric towards a regenerator, and afterwards, the regenerated signal is switched to the intended output channel in the same switching fabric.

In the switching station of FIG. 2, collisions may occur if a switching fabric receives communication signals intended for the same output channel from two demultiplexers. Namely, there is only one output port available at the switching fabric, which leads to the desired output channel. In such a situation, only one of the two signals can be switched.

FIG. 3 shows a block diagram of a cross connect according to the invention, in which this problem is solved. Input and output channels, multiplexers, demultiplexers and switching fabrics S1, . . . , SN are the same as in the embodiment of FIG. 2 and are not explained again. The second group output ports o′1, . . . , o′P of the switching fabrics S1, SN are led to input ports of a further optical switching fabric S′, the output ports of which are further connected to inputs of wavelength converters T1, T2, . . . , TQ. The wavelength converters all comprise a photo-diode which is sensitive to all wavelengths λ1, . . . , λN of the multiplex and which converts the optical communication signal coming from the switching fabric S′ into an electrical signal, electrical circuits connected thereto for impulse shaping and amplification, and a fixed-wavelength laser diode driven by the output signal of these electrical circuits, which provides the regenerated optical communication signal. The wavelength converters T1, T2, . . . , TQ thus also have a regenerating function. The output of each wavelength converter is wired by an optical fibre section to a second group input port of the switching fabric S1, . . . or SN which is assigned to the wavelength of said output.

The switching fabric S′ is adapted to interconnect all its input and output ports selectively, one by one. A communication signal that is to be shaped can therefore be supplied via the fabric S′ to a wavelength converter having any desired output wavelength of the multiplex, including the present wavelength of the communication signal. This latter case corresponds to a simple regeneration of the communication signal, without a simultaneous wavelength conversion.

The switching fabrics S1, . . . , SN are shown here with two second group input and output ports each, but it is obvious that the number of these ports can be selected arbitrarily between 1 and M.

FIG. 4 shows a further advanced embodiment of the cross connect. The cross connect of FIG. 4 is distinguished from that of FIG. 3 by the fact that in the former the wavelength converters T1, . . . , TQ comprise, instead of a fixed-frequency laser diode, a laser diode which is tuneable to the different wavelengths λ1, . . . , λN of the multiplex, or at least to a plurality of these wavelengths. In order to enable a communication signal that has been converted in such a wavelength converter to be forwarded to that fabric among switching fabrics S1, . . . , SN which is assigned to the wavelength of the converted signal, a third switching fabric S″ is required between the outputs of the wavelength converters T1, . . . , TQ and the second group input ports of the switching fabrics S1, . . . , SN. The number of tuneable wavelength converters which is required in order to achieve a given measure of security against wavelength collisions in the cross connect is smaller than in the embodiment of FIG. 3 having fixed-frequency wavelength converters. The economy is the greater, the bigger the number N of wavelength of the multiplex is. Therefore, in spite of the additional switching fabric and the more elaborate wavelength converters, it may be possible to design a cross connect according to FIG. 4 more compactly and more economically than a cross connect according to FIG. 3.

Moreover, the second and third switching fabrics S′, S″ are useful for dropping communication signals at the location of the cross connect itself towards receivers RX or to add communication signals from transmitters TX.

1-11. (canceled)

12. An optical cross-connect, comprising:
a) a first plurality of input channels for through data traffic;
b) a second plurality of output channels for the through data traffic;
c) a plurality of first optical switching matrices comprising a first group of input ports which are connected to the input channels of the cross-connect, and a first group of output ports which are connected to the output channels of the cross-connect, for interconnecting the input channels and the output channels;
d) a group of one or more signal shaping units formed as wavelength converters;
e) means for connecting a second group of output ports of the first optical switching matrices to a respective input of a signal shaping unit of the group, and means for connecting a second group of input ports of the first optical switching matrices with a respective output of one of the signal shaping units;
f) each of the first switching matrices being operative for switching communication signals at a same wavelength assigned to the first switching matrices; and
g) the connecting means being operative for connecting an input and an output of one of the wavelength converters with different ones of the first switching matrices.

13. The optical cross-connect of claim 12, in that the connecting means comprises wired lines between the output or the input of one of the signal shaping units, and the input port or the output port, respectively, of the first switching matrices.

14. The optical cross-connect of claim 12, in that the connecting means comprises switching elements for selectively connecting the output or the input of one of the signal shaping units to one of several of the input ports or output ports, respectively, of the first switching matrices.

15. The optical cross-connect of claim 12, in that each signal shaping unit is operative for shaping an individual communication signal.

16. The optical cross-connect of claim 12, in that the connecting means comprises at least one second switching matrix with selectively connects a second group of output ports of the first switching matrices to said one wavelength converter.

17. The optical cross-connect of claim 16, in that the connecting means comprises at least a third switching matrix which selectively connects the wavelength converters to one of a second group of input ports of the first switching matrices.

18. The optical cross-connect of claim 12, in that each input channel is connected to the first switching matrices via a wavelength demultiplexer and/or the first switching matrices are connected to each output channel via a wavelength multiplexer.

19. The optical cross-connect of claim 12, and comprising inputs and/or outputs for branching the through data traffic, and means for connecting these inputs or outputs to a second group of input or output ports of the first switching matrices.

20. The optical cross-connect of claim 12, in that each wavelength converter has a wavelength-tuneable transmitter part.

21. The optical cross-connect of claim 12, in that the first group of input ports are connected to the input channels and/or the first group of output ports are connected to the output channels, respectively, without a switching matrix being inserted in between.

22. A method of switching a communication signal in an optical cross-connect having a plurality of switching matrices connected in parallel between a plurality of input channels and a plurality of output channels, each of the switching matrices being operative for switching communication signals of a same wavelength assigned to it, the method comprising the steps of:
a) receiving the communication signal by one of the input channels of the cross-connect;
b) assigning one of the output channels of the cross-connect to the communication signal;
c) deciding whether a wavelength conversion of the communication signal has to be carried out;
d) inputting the communication signal into the switching matrix assigned to its wavelength;
e) if a wavelength conversion was found necessary in step c):
i) outputting the communication signal at an output port of the switching matrix which is connected to a wavelength converter,
ii) carrying out the wavelength conversion, and
iii) inputting the communication signal into another switching matrix from the plurality of parallel switching matrices to which a converted wavelength of the communication signal is assigned; and
f) outputting the communication signal from the switching matrix to the output channel assigned to it.
